(19) United States
(12) Patent Application Publication
(10) Pub. No.: US 2019/0001241 A1
(43) Pub. Date: Jan. 3, 2019

(54) NON-WELDED FILTER

(71) Applicant: MOTT CORPORATION, Farmington, CT (US)

(72) Inventors: Michael K. MILLER, Collinsville, CT (US); John E. ROSENBERGER, Plantsville, CT (US); Alfonso MARENA, Wethersfield, CT (US); James STEELE, Rockfall, CT (US); Jonathan BOLLUYT, Bristol, CT (US)

(21) Appl. No.: 16/016,747

(22) Filed: Jun. 25, 2018

Related U.S. Application Data
(60) Provisional application No. 62/527,582, filed on Jun. 30, 2017.

(51) Int. Cl. B01D 29/15; B01D 46/24

(52) U.S. Cl. CPC B01D 29/15; B01D 46/2407; B01D 2201/345; B01D 2201/4092; B01D 2265/029; B01D 2201/342; B01D 2271/022

(57) ABSTRACT

Embodiments of the present invention include systems and methods for providing a filter that is sealed solely with mechanical forces. The filter may be a high pressure filter used in semiconductor manufacturing. In various embodiments, the filter includes a housing with an angled end and a filter element disposed inside the housing. The filter further includes a fluid fitting with an angled side. The angled side of the fitting has a different angle than the angled end of the housing. The filter also includes a compression collar fitted over the housing to compress the housing and the fitting. The result is a filter that may be used as a high-pressure fluid restrictor. The filter uses only mechanical seals to provide leak-proof highly filtered fluids in which impurities, contaminants and particulates are removed.

### RELATED APPLICATIONS

The present application claims priority to U.S. Provisional Application Ser. No. 62/527,582, filed on Jun. 30, 2017 and entitled “NON-WELDED FILTER.” The contents of the aforementioned application are incorporated herein by reference.

### TECHNICAL FIELD

Embodiments of the present invention relate generally to liquid and/or gas flow filters.

### BACKGROUND

There are numerous applications requiring structures that are used for the filtration and/or flow control of fluids, such as gases and liquids. Although conventional structures have been successfully manufactured and used for flow control and filtration applications, some systems require the fluids to obtain a higher level of purity than is currently available. Furthermore, conventional structures are not able to accurately function in a high temperature and high pressure atmosphere. For example, semiconductor manufacturing requires a high level of purity in the filtration of fluids in a high pressure and high temperature atmosphere. Accordingly, a need exists for structures and methods of filtration that more reliably produce a high-pressure, high-purity filter and flow device.

### SUMMARY

Embodiments of the present invention include systems and methods for providing a filter that is sealed solely with mechanical forces. The filter may be a high pressure filter used in semiconductor manufacturing. In various embodiments, the filter includes a housing with an angled end and a filter element disposed inside the housing. The filter further includes a fluid fitting with an angled side. The angled side of the fitting has a different angle than the angled end of the housing. The filter also includes a compression collar fitted over the housing to compress the housing and the fitting. The result is a filter that may be used as a high-pressure fluid restrictor. The filter uses only mechanical seals to provide leak-proof highly filtered fluids in which impurities, contaminants and particulates are removed.

### BRIEF DESCRIPTION OF THE DRAWINGS

FIG. 1 illustrates a section view of a non-welded filter with a double joint, in accordance with an embodiment of the present invention.

FIG. 2 illustrates a section view of a non-welded filter with a single joint, in accordance with an embodiment of the present invention.

### DETAILED DESCRIPTION OF THE PREFERRED EMBODIMENTS

The present invention utilizes a filter that can be used in filtration devices, flow control devices, drug delivery devices, semiconductor manufacturing and similar uses. Generally, the filter described herein, when used in accordance with the present invention, results in a high purity fluid from which impurities, contaminants and particulates are removed. In an embodiment of the present invention, a filter includes a housing, one or two fittings and one or two threaded collars. The filter uses only a mechanical seal to connect the elements. The mechanical seal is achieved as the angled side of the fittings are forced to engage with the angled end of the housing under compression from the threaded collar. In an embodiment, the housing, the fittings and the threaded collars are each constructed using molybdenum.

In one embodiment, the flow path of the fluid through the filter is created by a high pressure liquid stream. The filter provides leak-proof performance at high temperatures and pressures. The pressure may be greater than 8,000 psi, 10,000 psi, 15,000 psi or 20,000 psi. The filter is leak-proof up to temperatures of about 400° C.

In one embodiment, the filter is used for semiconductor manufacturing. The filter includes reliable 9 LRV filtration down to 0.003 μm. The filter of the present invention provides efficient particle capture in order to remove impurities, contaminants and particulates from the fluids. The fluids which can be filtered in the present invention include both liquids and gasses. The fluids include low melting point metals at temperatures up to about 400° C., high purity gases, such as, but not limited to, hydrogen bromide, and other high purity fluids.

As used herein, “particulate,” “particles,” and “powder” are used synonymously to mean particles that are sized on the order of millimeters, micrometers or nanometers, and have any suitable shape such as spherical, substantially spherical (e.g., having an aspect ratio greater than 0.6, 0.7 or 0.8) and irregular, and mixtures thereof. A preferred particle size range for use in the present invention is less than 5 to 500 micrometers of powder used to fabricate the filter element. Contaminate particles in the fluid stream refers to particles from less than 0.05 micrometer (50 nanometer) to greater than 500 micrometers.

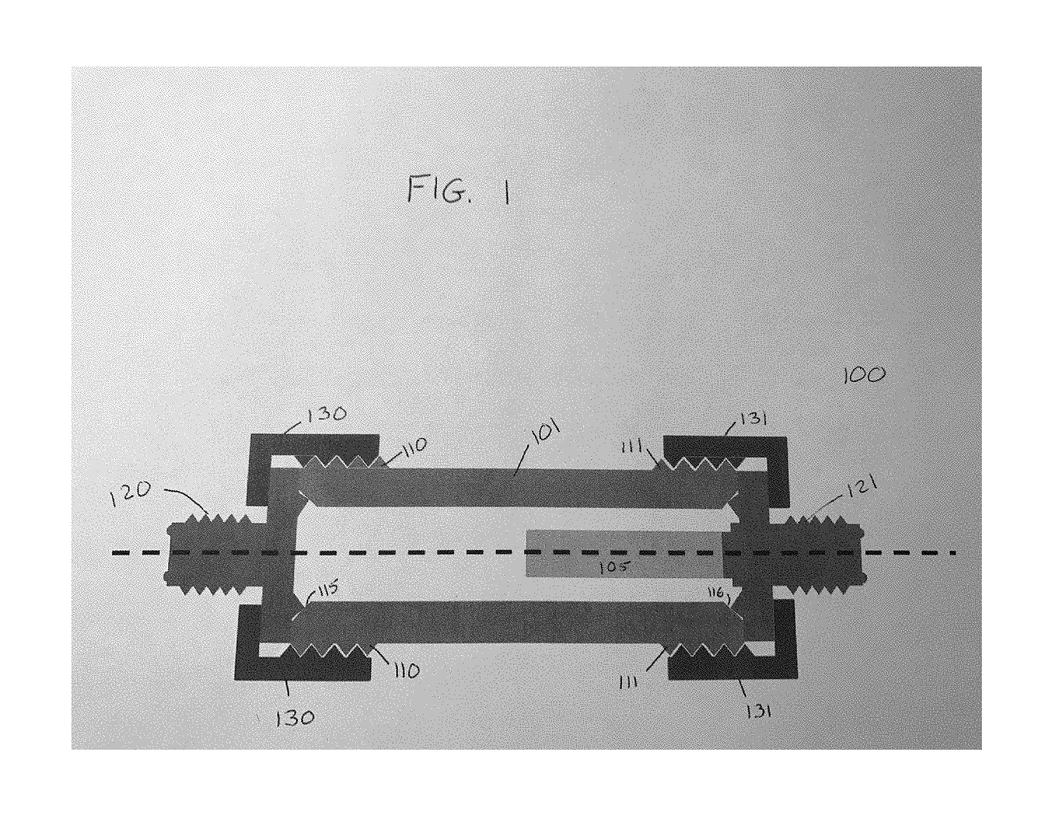

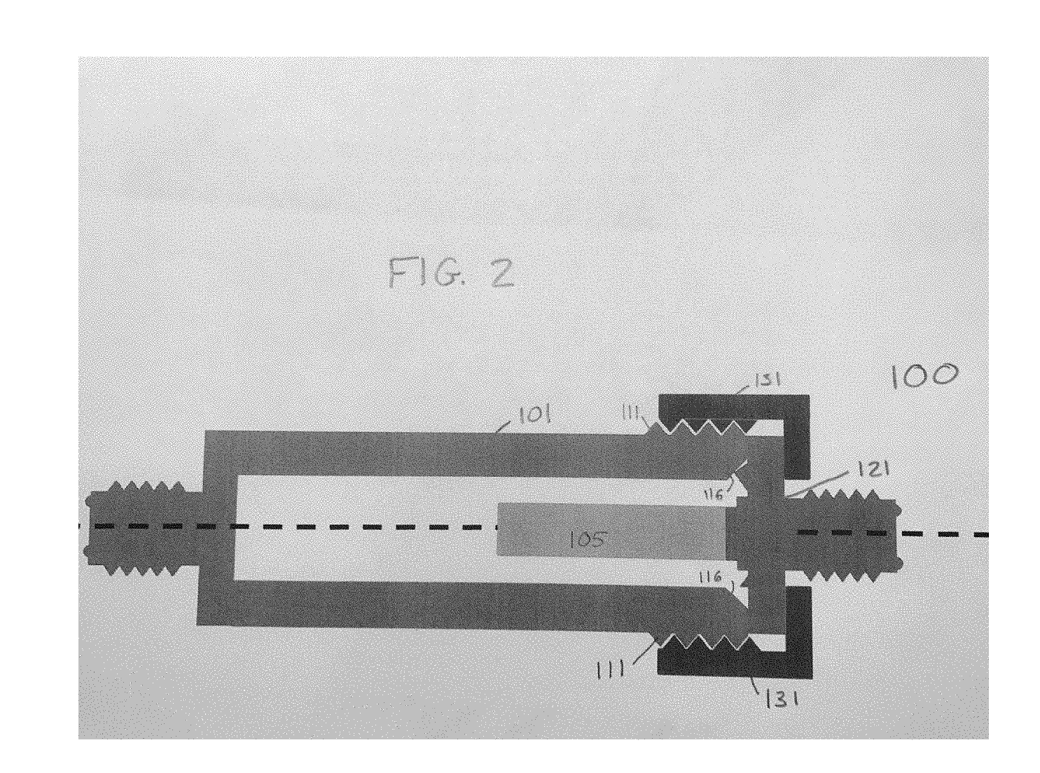

FIG. 1 illustrates a section view of a non-welded filter with a double joint, in accordance with an embodiment of the present invention. FIG. 1 includes a three-piece housing construction. FIG. 2 illustrates a section view of a non-welded filter with a single joint, in accordance with an embodiment of the present invention. FIG. 2 includes a two-piece housing construction. In FIG. 2, only one end of the housing 101 uses the mechanical seal, while FIG. 1 includes a mechanical seal for both ends of the housing 101. In FIGS. 1 and 2, the housing 101 of the filter 100 is constructed with molybdenum. Molybdenum is an advantageous material as it can withstand high pressure and high temperatures up to about 400° C.

In FIGS. 1 and 2, the housing 101 surrounds a filter element 105. In one embodiment, the filter element 105 is centrally located in the housing 101. In an alternate embodiment, the filter element 105 is located off-center and towards one side of the housing 101. As shown in FIGS. 1 and 2, the filter element is positioned towards one end of the housing 101. The filter element 105 is formed into any suitable configuration, such as tubular (as shown in FIGS. 1 and 2) or as a disc or cup.

As shown in FIG. 1, the housing 101 includes angles 110, 111 on its exterior or outer sides. FIG. 2 includes angles 110 on only one of the exterior or outer sides of the housing 101 as the other side of the housing 101 does not have an opening at the end. In FIGS. 1 and 2, the angles 110, 111 may form a pattern and/or the angles 110, 111 may randomly occur. The angles 110, 111 are machined into the housing 101. The angles 110, 111 on the side of the housing 101 project or protrude from the housing. Alternatively, the angles 110, 111 may regress into the housing. In one embodiment of FIG. 1, the angles 110 on a side of the housing 101 near a first end are different than the angles 111 on the side of the housing near the second end. Alternatively, the angles 110, 111 in FIG. 1 may be the same. The angles 110, 111 on the exterior side of the housing 100 may engage or connect with the threaded collars 130, 131 as further described below.

In addition to angles on the exterior sides of the housing 110, the housing also includes an angled or tapered end 115, 116 of the housing 101. FIG. 1 includes angled or tapered ends 115, 116 on both sides of the housing 101 while FIG. 2 includes an angled end 116 on only one side of the housing 101.

In FIG. 1, the housing 101 has an angled or tapered end 115, 116 on both sides. In one embodiment, the angles of the angled or tapered ends are the same on both sides of the housing 115, 116. In an alternative embodiment, the angled or tapered ends have different angles on each opening of the housing 115, 116. For example, the angled end 115 on the first end of the housing 101 may be a different angle than the angled end 116 on the second end of the housing 101. The housing 101 in FIG. 1 has one or more protruding angles of the angled or tapered ends 115, 116 on the housing 101. However, the housing 101 may have one or more inverted angles of the angled or tapered end 115, 116 or another configuration. The angled or tapered end 115, 116 of the housing 101 engages or connects with the fittings 120, 121.

FIG. 1 depicts two fittings 120, 121 in the filter 100. Alternatively, FIG. 2 depicts only one fitting 121 in the filter 100. In FIG. 1, one fitting 120 is located at a first end of the housing 101 and a second fitting 121 is located at a second end of the housing 101. In one embodiment, the fittings 120, 121 are fluid fittings. The fluid fittings 120, 121 are in fluid communication with the filter element 105. The fluid fittings 120, 121 provide inlet and outlet ports to the filter 100. For example, filter 100 may use high pressure to filter a fluid (i.e. liquid or gas) into the inlet port of fitting 120, through the housing 101 and through the filter element 105. The high pressure may be used to filter the fluid so that the impurities, contaminates and particulates are filtered by the filter element 105 and only the filtered fluid exits through the outlet port of the fitting 121.

As shown in the embodiment of FIG. 1, the fittings 120, 121 have angled sides. The angled sides of the fitting 120, 121 are located on the interior side of the fitting. The interior side of the fitting 120, 121 connects to the opening of the housing 101. The interior side of one of the fittings 121 will also connect to the filter element 105. The angled sides of the fittings 120, 121 are similar to a knife edge feature as FIGS. 1 and 2 depict a pointed protruding angle on the interior side of the fitting. In one embodiment, the fittings 120, 121 have angled sides that are created by machining. The fittings 120, 121 are connected to the opening of the tapered or angled ends 115, 116 of the housing 101. The angled sides of the fittings 120, 121 are machined to be purposefully different angles than the angled ends 115, 116 of the housing 101. The angled sides of the fittings 120, 121 have angles with different degrees with respect to an axis in the center of the filter than the angles of the angled ends 115, 116 of the housing 101. In one embodiment, the difference in degrees between the angles of the fittings 120, 121 and the angles of the angled ends 115, 116 of the housing 101 may be more than one degree. By having differently angled sides on the fitting 120, 121 when compared with the angles on the angled ends 115, 116 of the housing 101, a mechanical seal is achieved through compression by the threaded collar 130, 131. The mechanical seal will advantageously provide a strong seal which will ensure that no liquid passes through the housing 101 to the fittings 120, 121 without being filtered through the filter element 105.

In the embodiment of FIG. 1, the two threaded collars 130, 131 engage the housing 101. Alternatively, FIG. 2 has a single threaded collar 131 which engages the housing 101. The threaded collars 130, 131 each have a corner edge around the housing. The threaded collars 130, 131 are characterized by threads on their interior sides that engage the threads 110, 111 on the exterior side of the housing 101. In one embodiment, the threaded collars 130, 131 have machined angles for fitting the collars onto the housing 101 and the fittings 120, 121. In one embodiment, the threaded collars 130, 131 have protruding angles. In an alternate embodiment, the threaded collars 130, 131 have inverted angles or an alternate configuration. The threaded collars 130, 131 create a mechanical seal by compressing the fittings 120, 121 and the housing 101.

The angles of the threads on the interior side of the threaded collar 130, 131 may be the same as, or are preferably different from, those of the threads 110, 111 on the exterior side of the housing 101. The interaction between the threads on the interior side of the threaded collar 130, 131 and the threads 110, 111 on the exterior side of the housing 101 assist in forming a mechanical seal.

The mechanical seal is created by compression forces created by the threaded collars 130, 131. The compression from the threaded collars 130, 131 occur as the threaded collars are fit over the fittings 120, 121 and the housing 101. Furthermore, the mechanical seal is created as the angles on the fittings 120, 121 are forced to engage with the different angles of the angled ends 115, 116 of the housing 101 under compression from the threaded collars 130, 131. As such, only the mechanical engagement of the threaded collars 130, 131 with the fittings 120, 121 and the housing 101 is used to seal the filter 100. No welding is used in the creation of the filter 100. The mechanical seal is strong enough that no other type of seal, such as those created by gasket or welding procedures, is needed.

As shown in FIG. 1, the filter 100 may contain up to three difference surfaces that stop the motion of the threaded collar 130, 131. In one embodiment, there is a flat shoulder on the fittings 120, 121 that may seat onto the non-angled portion of housing 101. In one embodiment, the interfering non-matching angles on the interior of fittings 120, 121 may bite into housing 101. In one embodiment, the exterior threads 110, 111 have different angles than threaded collar 130, 131, to create a seal such as, but not limited to, a NPT type seal.

In an alternative embodiment, the filter 100 includes a mechanical stop. In one embodiment, the mechanical stop may be two mating surfaces (not necessarily shown in FIG. 1 or FIG. 2) on fittings 120, 121 and housing 101 making contact. The contact may control and limit the degree of travel of the angled surfaces on fittings 120, 121 into the angles surfaces on the housing 101.

In an embodiment, a fluid may enter the filter 100 through the fittings 120, 121 and under compression from the threaded collar 130, 131. The filter 100 may use high pressure to cause the fluid to enter the inlet port of the fitting 120. The seal between the angled sides of the fittings 120, 121 and the angled ends 115, 116 of the housing 101, which are compressed by the threaded collars 130, 131, mechanically seals the filter 100 and cause the fluid to be filtered through the filter element 105. The filtered fluid is released via the outlet port of the fitting 121.

Certain embodiments of the present invention are described above. It is, however, expressly noted that the present invention is not limited to those embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the present invention. As such, the invention is not to be defined only by the preceding illustrative description and examples.

1. A filter comprising:
a housing comprising a tubular structure having an outer surface, an inner surface forming an internal space, a first end, a second end, and a longitudinal axis, wherein the inner surface comprises a first angled portion that intersects with the first end at a first, non-orthogonal angle;
a filter element disposed within the internal space of the housing;
a fitting with a fitting surface that contacts the angled portion of the housing inner surface, wherein the fitting surface forms an angle with respect to the longitudinal axis of housing that is different from the first, non-orthogonal angle; and
a first compression collar fitted over the housing.

2. The filter of claim 1, wherein the filter comprises molybdenum.

3. The filter of claim 1, wherein the filter does not comprise a weld.

4. The filter of claim 1, wherein the filter element is centrally located in the internal space of the housing.

5. The filter of claim 1, wherein the filter element is positioned off-center within the internal space of the housing.

6. The filter of claim 1, wherein the second end of the housing is closed.

7. The filter of claim 1, wherein the second end of the housing is open.

8. The filter of claim 7, wherein the housing inner surface comprises a second angled portion that intersects with the second end at a second, non-orthogonal angle.

9. The filter of claim 8, wherein the first, non-orthogonal angle is different from the second, non-orthogonal angle.

10. The filter of claim 8, wherein the first, non-orthogonal angle is the same as the second, non-orthogonal angle.

11. The filter of claim 1, wherein the fitting provides an inlet port to the filter.

12. The filter of claim 1, further comprising a second compression collar fitted over the housing.

13. The filter of claim 1, wherein the fitting comprises a flat shoulder portion in contact with a non-angled portion of the housing.
